(19) United States
(12) Patent Application Publication
(10) Pub. No.: US 2005/0023942 A1
(43) Pub. Date: Feb. 3, 2005

(54) Steel cabinet drawer file

(75) Inventor: Surapol Kunanantakul, Bangkok (TH)

Correspondence Address: VOLPE AND KOENIG, P.C., UNITED PLAZA, SUITE 1600, 30 SOUTH 17TH STREET, PHILADELPHIA, PA, 19103, US

(73) Assignee: Siam Steel International Public Company Limited, Samutprakarn (TH)

(21) Appl. No.: 10/639,290

(22) Filed: Aug. 11, 2003

(30) Foreign Application Priority Data
Nov. 11, 2002 (TH) 077928

(51) Int. Cl. E05C 7/06

(52) U.S. Cl. 312/221

(57) ABSTRACT

A lock system for a file drawer having an extendable element locking system and interlock system having a common lock bar. A lock system comprising of a lock bar having three pins that will lock the drawer whether the key lock is locked, and that will prevent more than one drawer from opening at the same time whether the locking system is locked or unlocked.

### FIELD OF INVENTION

The present invention relates a steel cabinet file drawer that can be easily assembled and disassembled.

### SUMMARY

The present invention relates to a steel cabinet file drawer which can be easily assembled and disassembled according to the method of the present invention. The file drawer accommodates A4, legal or Foolscap files by adjusting the position of the hanging rail bar, which is included with the unit. The drawer includes back, side and bottom panels, and is specially designed for heavy-duty use for storage of books and other heavy things or documents inside the drawer.

The drawer is packaged as a ready to assemble (RTA) unit that can be easily assembled without any special technical knowledge. The structure and components of the cabinet are firm and strong, but also light, so that all of the components can be packed together in a flat package, which reduces the cost of transportation, storage and packing.

The file drawer conforms with U.S. furniture standards (ANSI/SOHO), including the Extendable Element and Cycling standards.

### BRIEF DESCRIPTION OF THE DRAWING(S)

FIG. 1 is an exploded view of the file drawer in accordance with an embodiment of the invention having two drawers;

FIG. 1.11 is an exploded view of the file drawer in accordance with an embodiment of the invention having four drawers;

FIG. 2 shows how to assemble the bottom panel with the bottom U-beam (knock-down drawer);

FIG. 3 shows how to assemble the left and right panel with the bottom panel and the bottom U-beam;

FIG. 4 shows how to assemble the top U-beam with the left and right panel;

FIG. 5 shows how to assemble the back panel with the left and right panel and bottom panel;

FIG. 6 shows how to assemble the top panel with the top U-beam, left and right panel and back panel;

FIG. 7 shows how to assemble the lock bar with the left panel, and the lock set with the top panel through the top U-beam;

FIG. 8 shows how to assemble the interlock and the case rail (knock-down);

FIG. 8.1 shows how to assemble the case rail with the side panel (welded);

FIG. 9 shows how to unfold the drawer body;

FIG. 10 shows how to assemble the back panel with the drawer body;

FIG. 11 shows how to assemble the front drawer with the drawer body (knock-down);

FIG. 11.1 shows how to weld each part of the drawer body together (welded);

FIG. 12 shows how to assemble the handle with the front drawer, and the hanging rail bar with the drawer body;

FIG. 13 shows how to assemble the drawer into the cabinet body;

FIG. 14 shows the detail of the lock bar;

FIG. 15 shows the position of the pin of the lock bar with interlock and the pin of the lock bar with the plastic ramp;

FIG. 16 shows how to assemble the case rail slide with the mounting bracket;

FIG. 17 shows the detail structure of the U-beam; and,

FIG. 18 shows the detail of the hanging rail bar.

### DETAILED DESCRIPTION OF THE PREFERRED EMBODIMENT(S)

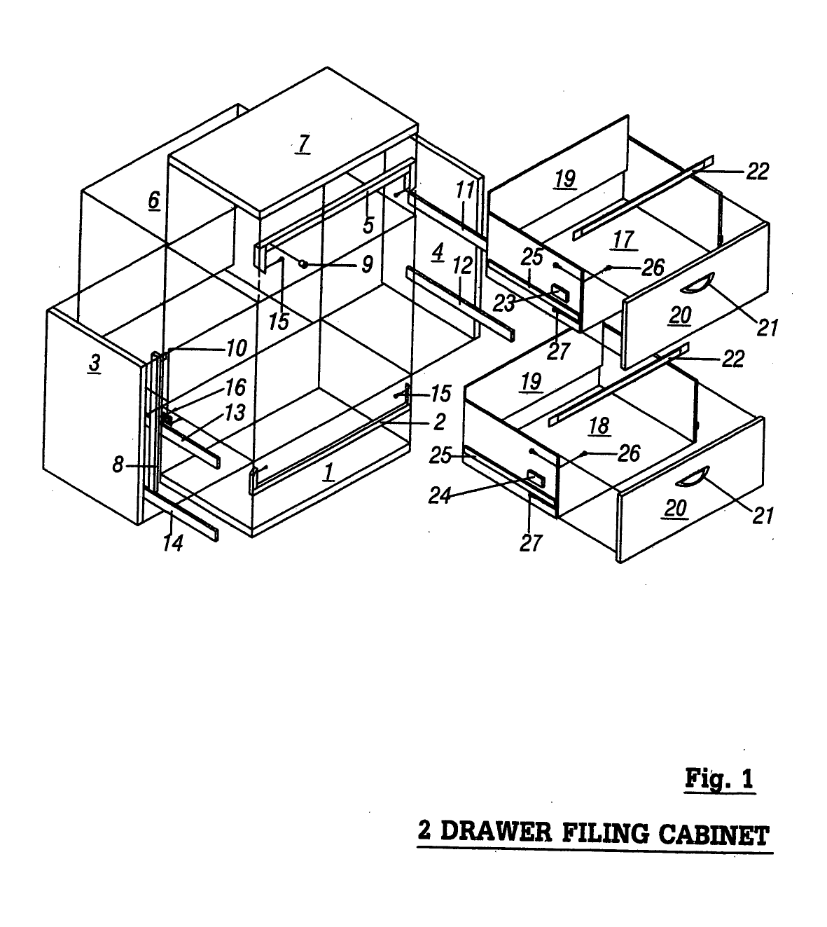

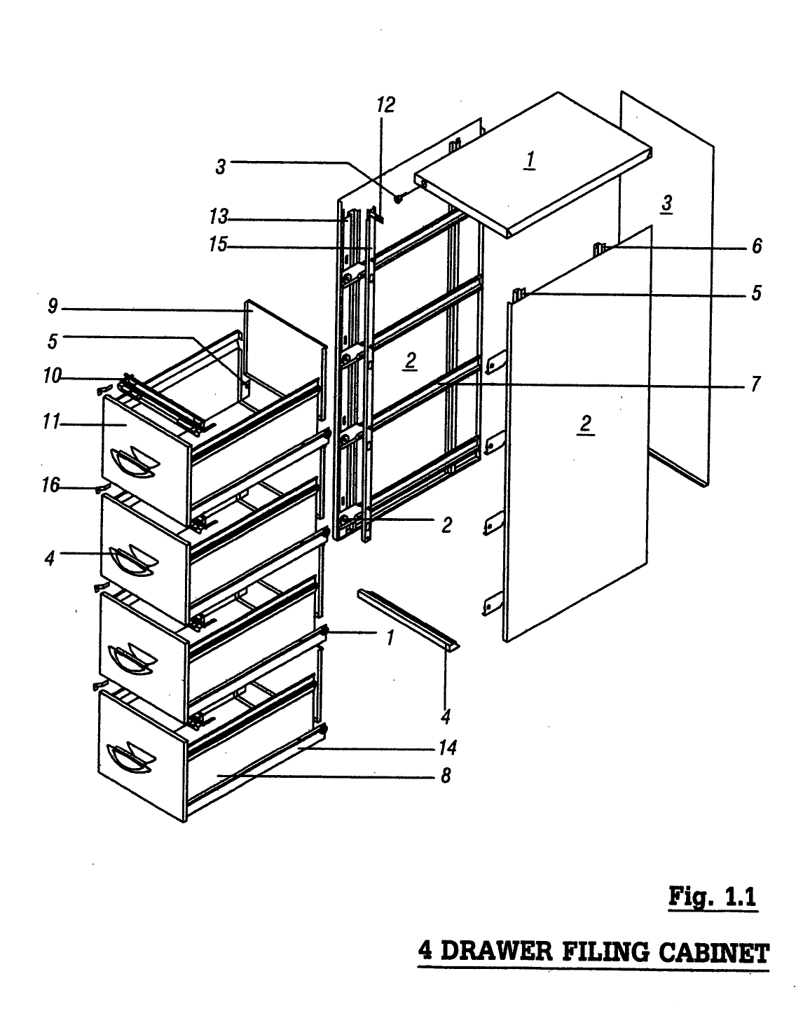

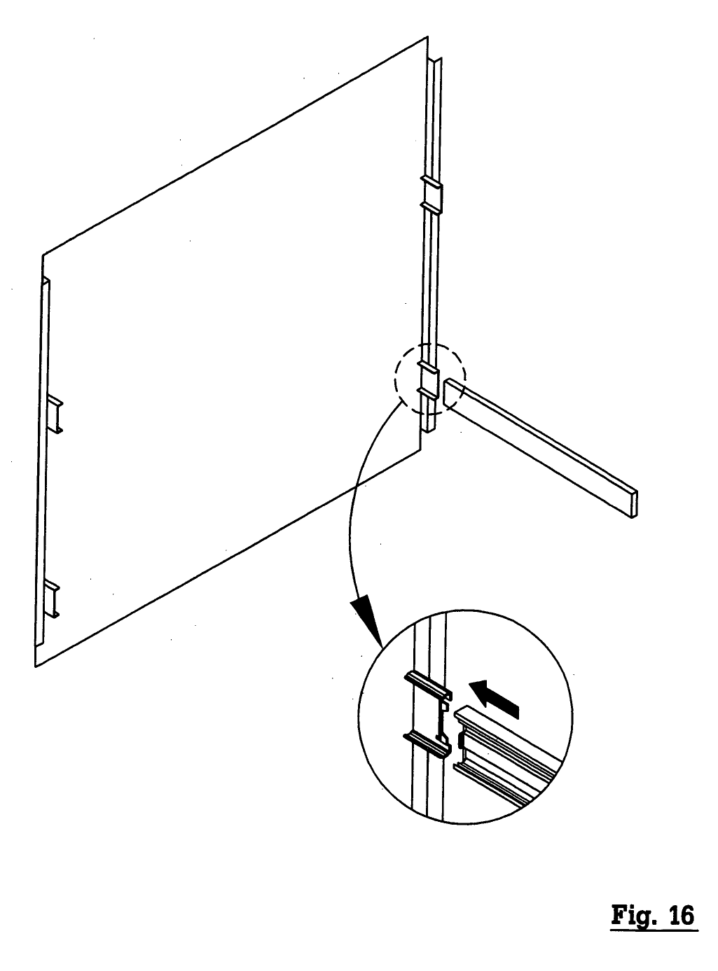

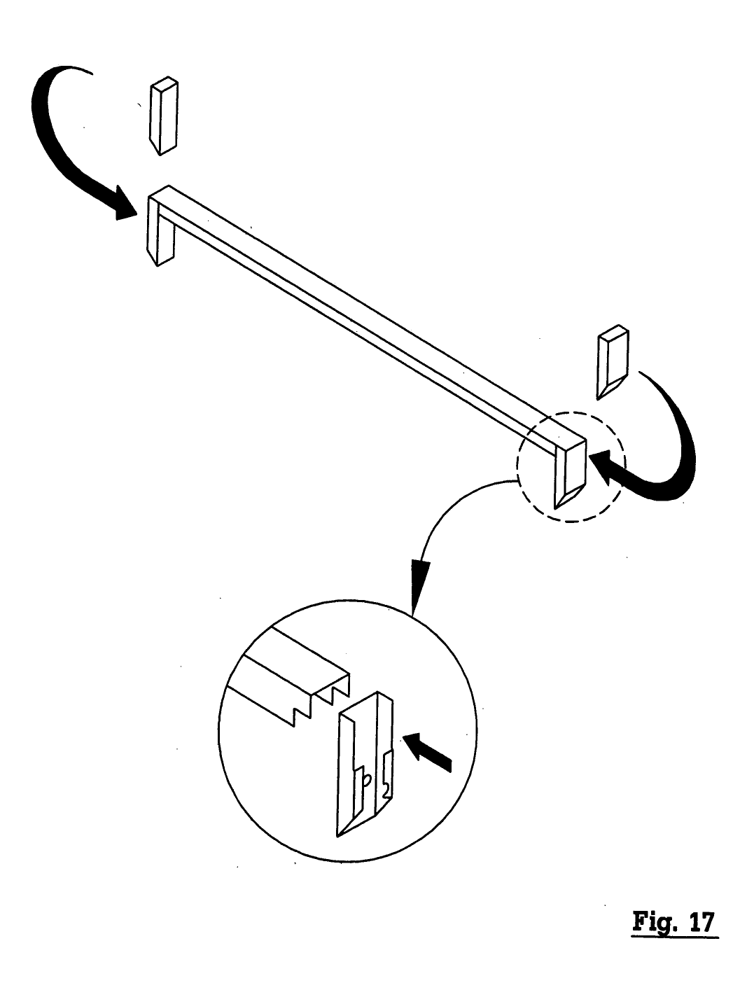

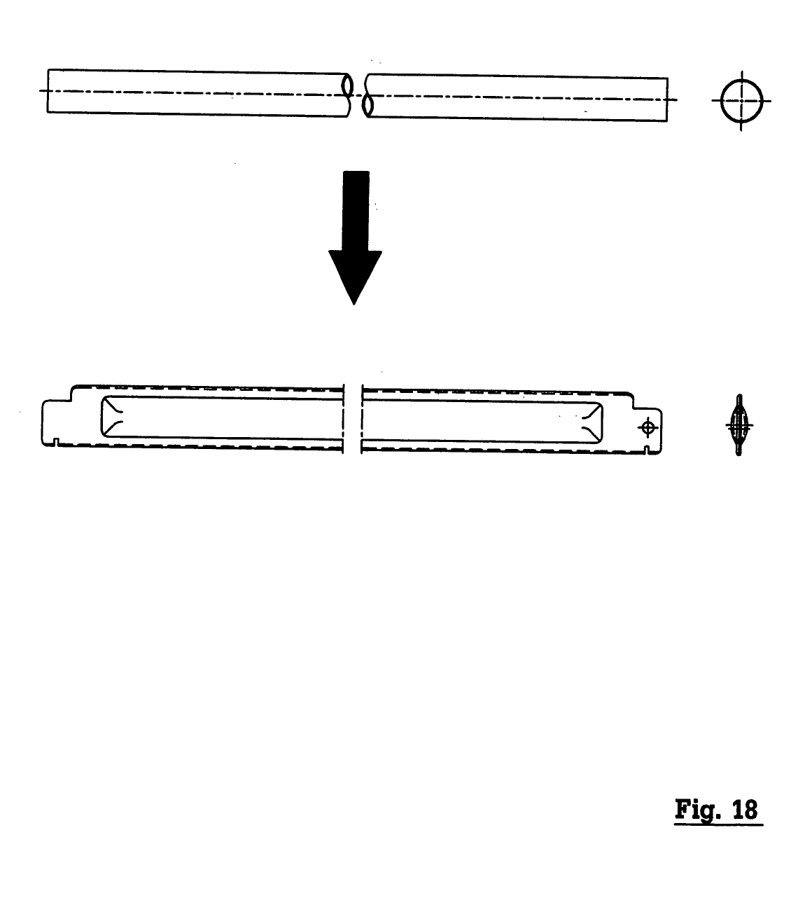

The file drawer and method of the present invention are described with reference to FIGS. 1-18 wherein like reference numerals are use throughout to designate like elements.

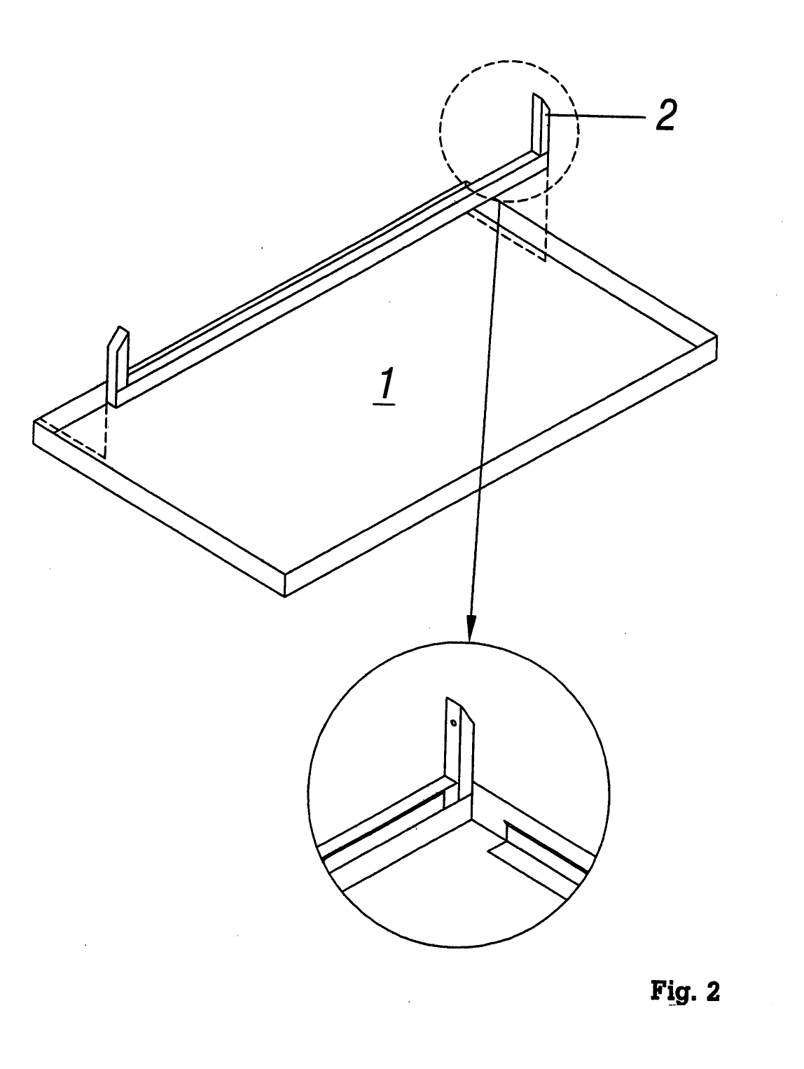

The file drawer, designated generally by reference numeral 30, is shown in a disassembled configuration in FIGS. 1 and 1.1. The method of assembling the file drawer in accordance with the invention is described with reference to FIGS. 2-18.

The file drawer 30 includes the following elements: bottom panel 1; bottom U-beam 2; left side panel 3; right side panel 4; top U-beam 5; back panel 6; top panel 7; lock bar 8; insert lock 9; interlock 10; case rail slide 11-14; screws 15, 16.

The file drawers comprise the following elements: bottom panels 17, 18; back panel 19; front panel 20; handles 21; hanging rail bar 22; plastic ramp 23, 24; rail slide 25; screws 26; and bolts 27, 28.

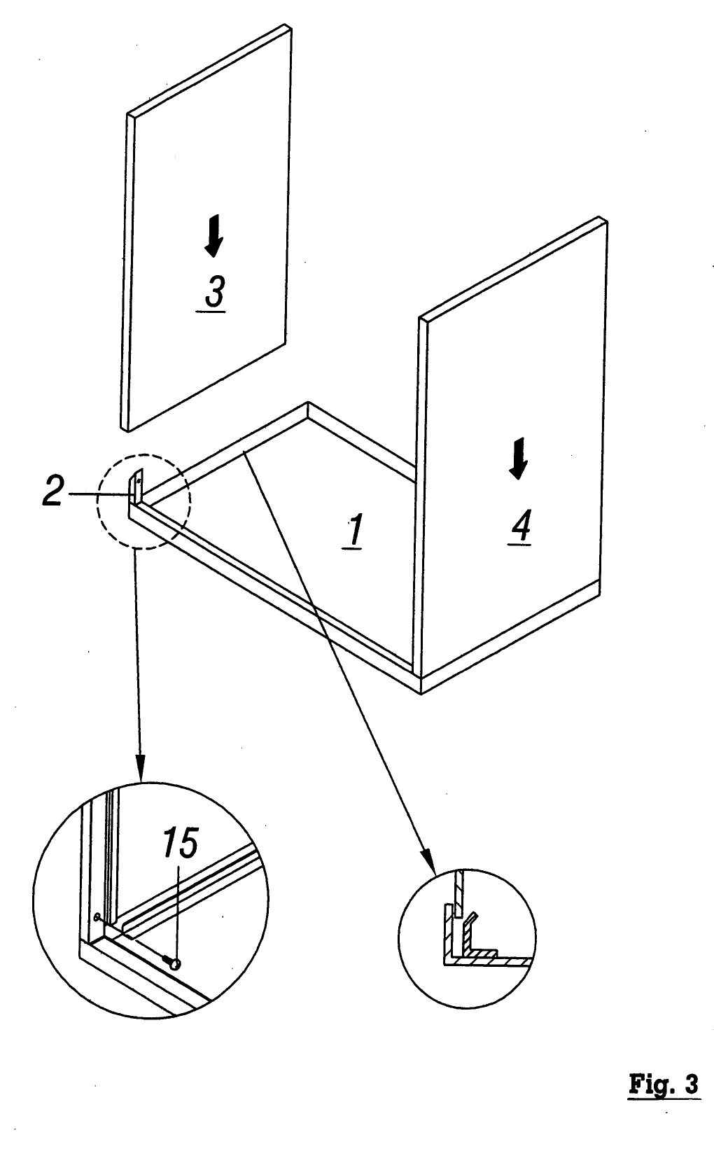

The file drawer is assembled in accordance with the following steps. The bottom U-beam 2 is attached under the front edge of the bottom panel as seen in FIG. 2. Referring to FIG. 3, slide the left panel 3 onto the U-beam 2 and down into the bottom panel and ensure that the lock tabs are fully snapped into place. Repeat this step with the right panel 4. Then, insert two screws 15 at the bottom side of both panels to connect the panels together.

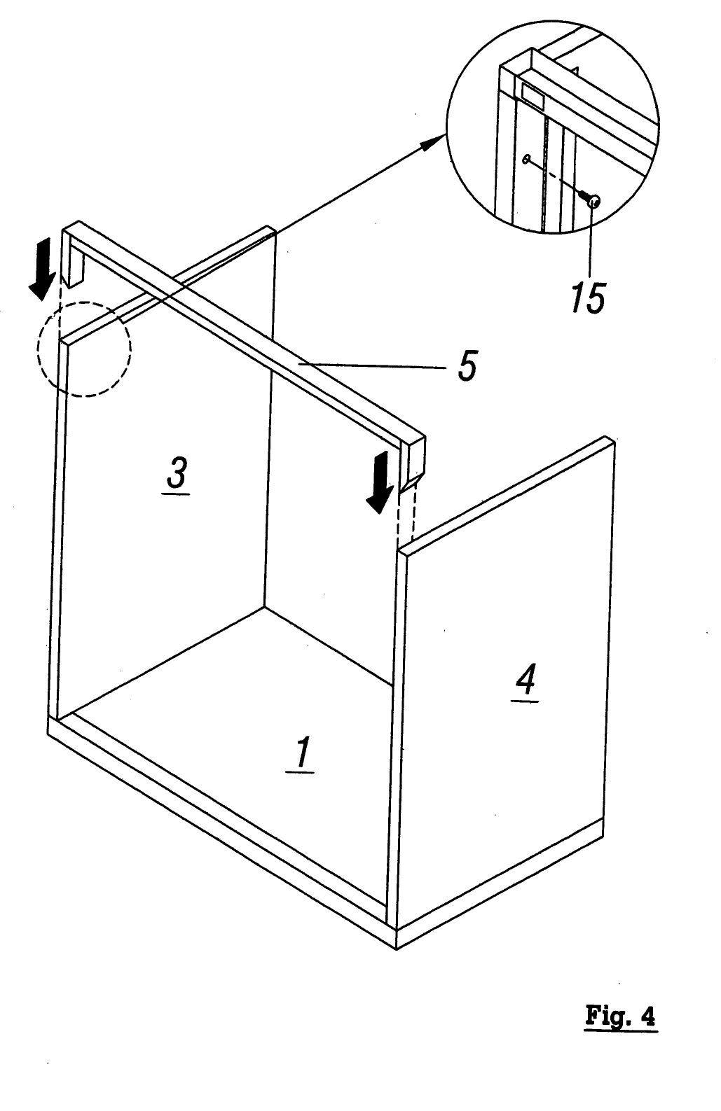

Referring to FIG. 4, slide the top U-beam 5 onto the left panel 3 and right panel 4 by orienting the U-beam downwardly. The U-beam 5 has a rectangular hole for receiving a lockset on the top left corner. Ensure that the lock tabs are fully snapped into place. Then insert two screws 15 at the top side of both panels to secure the panels to the U-beam.

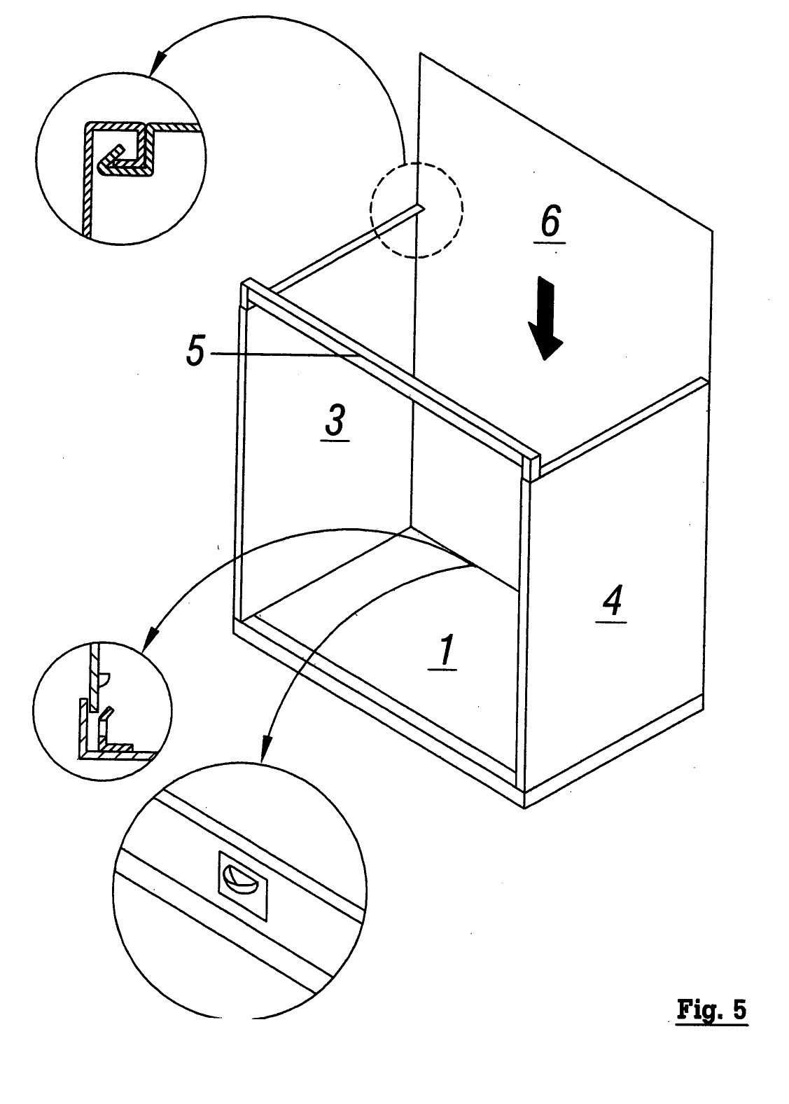

Referring to FIG. 5, slide the back panel 6 down into slots in the left panel 3 and right panel 4. The side edge of the back panel 6 is folded like a “C” that will hold the panels together. Buttons at the bottom of the back panel engage three pre-cut slots in the bottom panel.

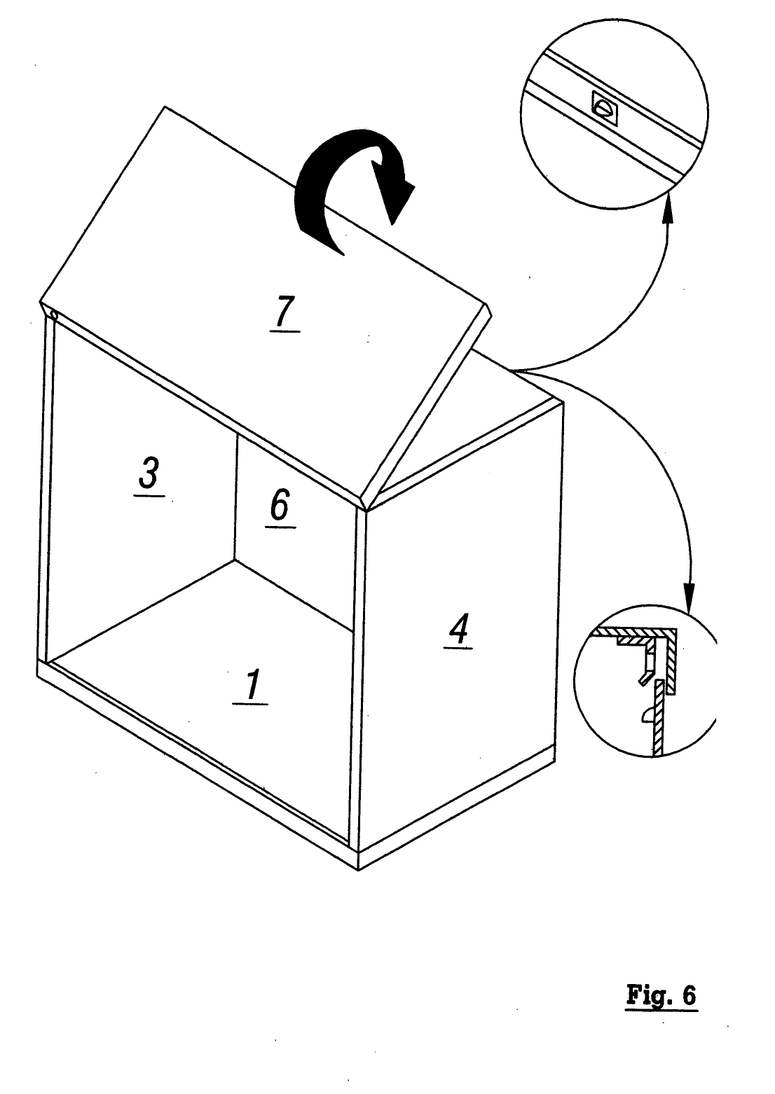

Referring to FIG. 6, slide the top edge of the top panel 7 under the top U-beam 5 with the keyhole faced outwardly. Then attach the front panel to the assembly so that the edging of the left panel 3, right panel 4, and back panel 6 have been inserted in the slot of the top panel 7.

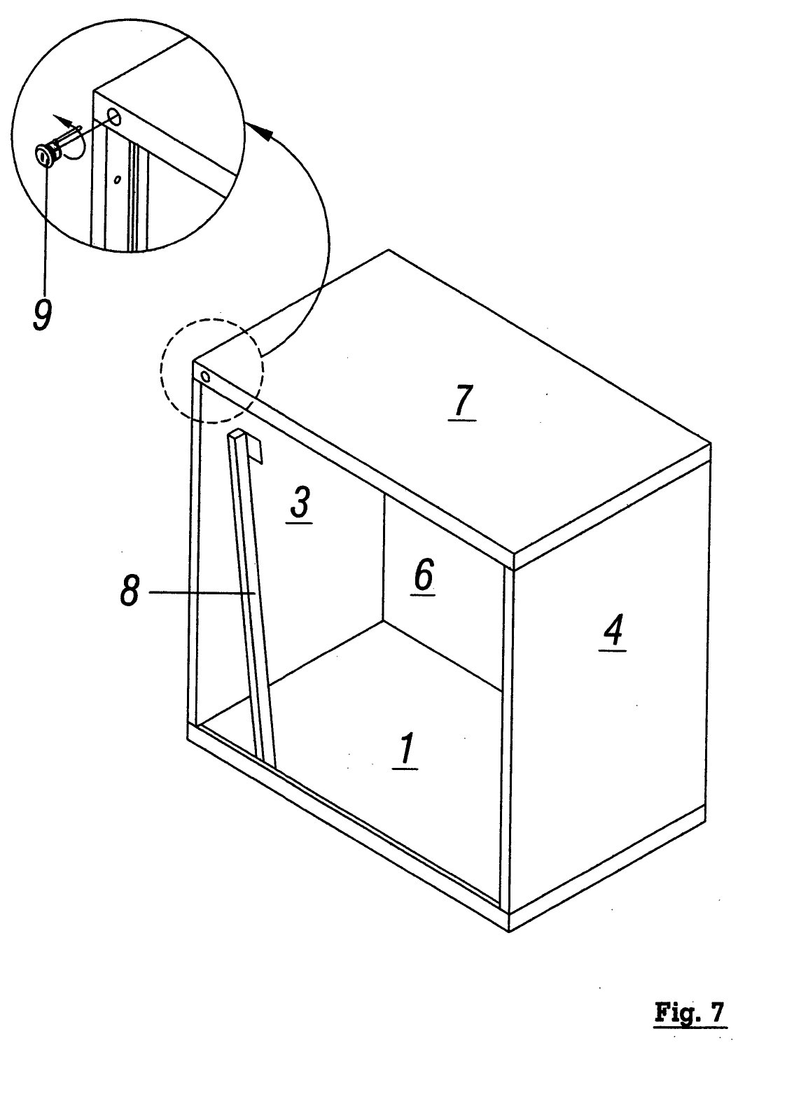

Referring to FIG. 7, insert the lock bar 8 into the front channel of the left panel 3 and insert lock 9 through the top panel 7.

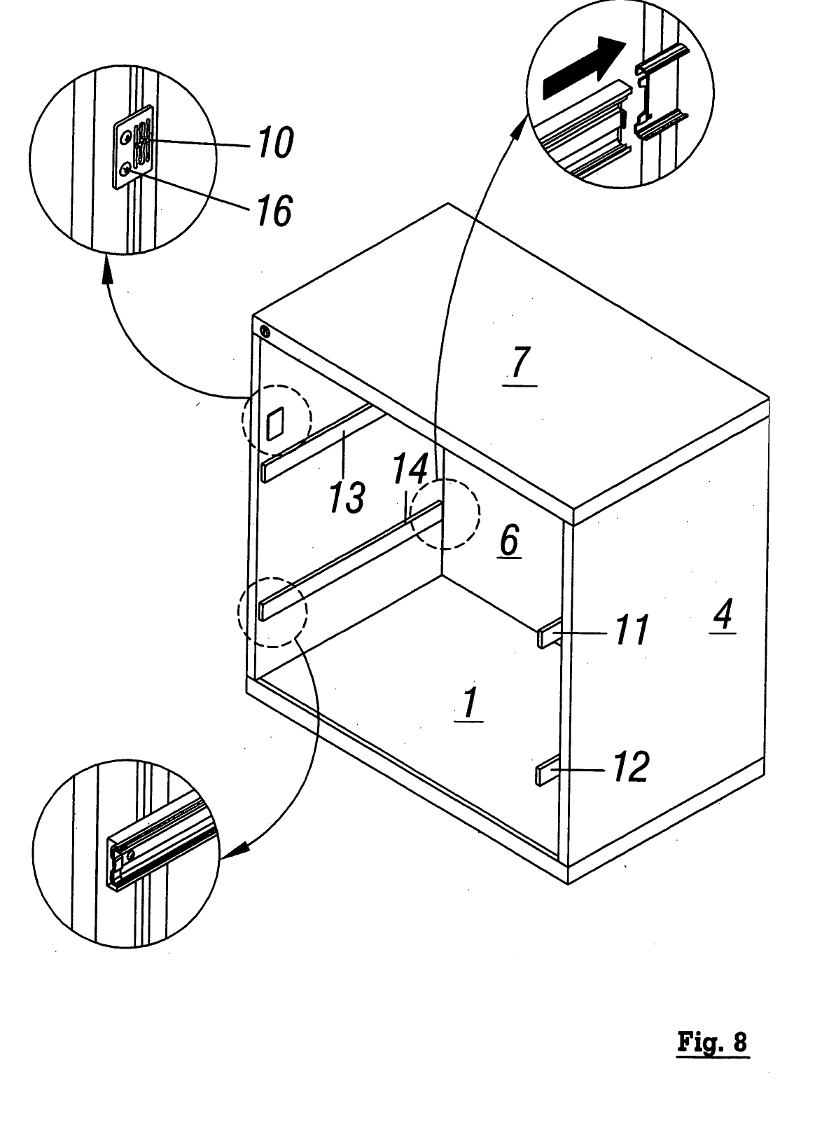

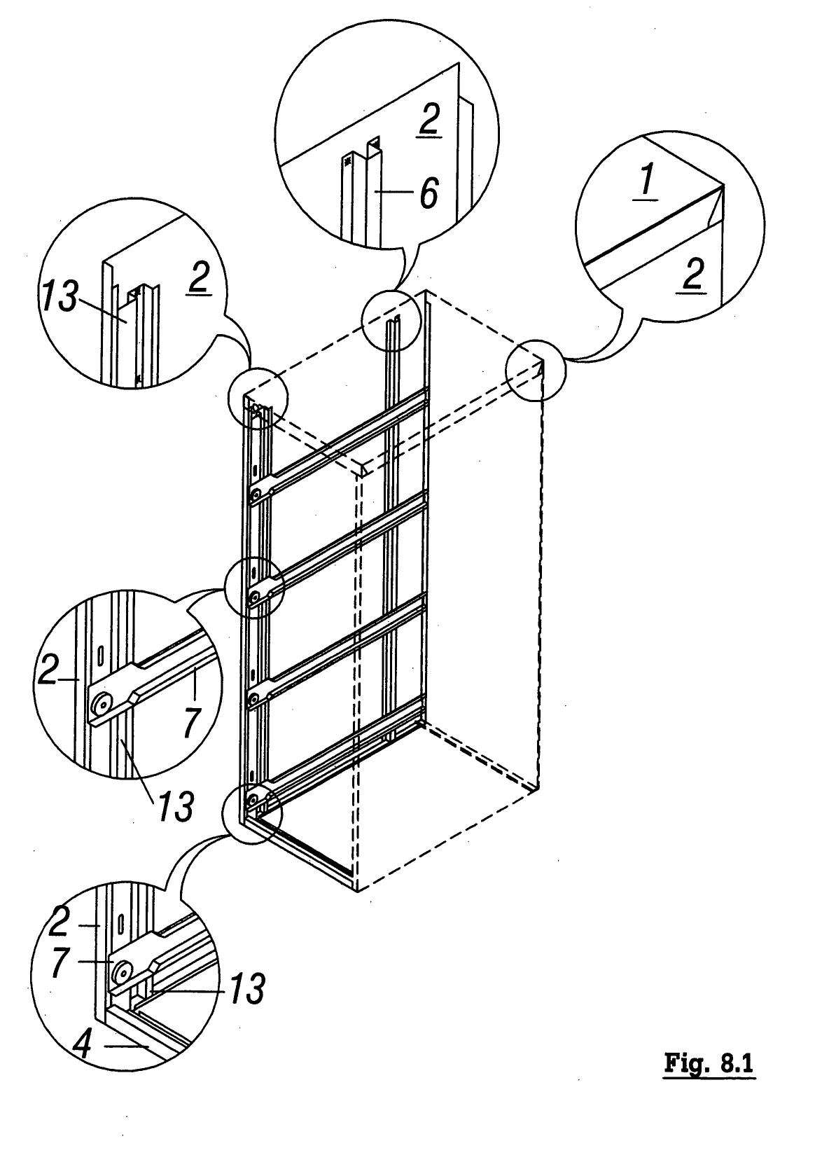

Referring to FIG. 8, attach the interlock 10 on the left panel with two screws 16 and insert the tab of case rail slides 11-14 on the left panel 3 and the right panel 4 with four screws 15. Insert the rear end of the case rail slides 11-14 into the mounting bracket of the back panel 6.

Referring to FIG. 8.1, spot weld the left panel, right panel, top panel, back panel, and bottom panel where indicated, to make the structure strong, rigid, and stable.

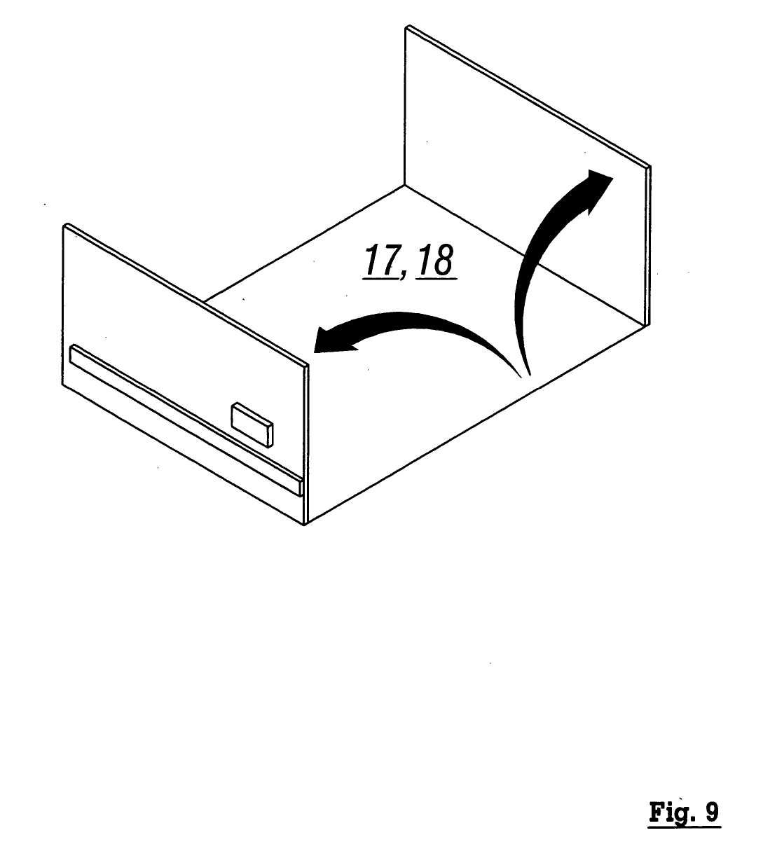

Next, assemble the drawers of the unit. Referring to FIG. 9, unfold both sides of the drawer body in which there will be a precut all the way to make it easy to lift up.

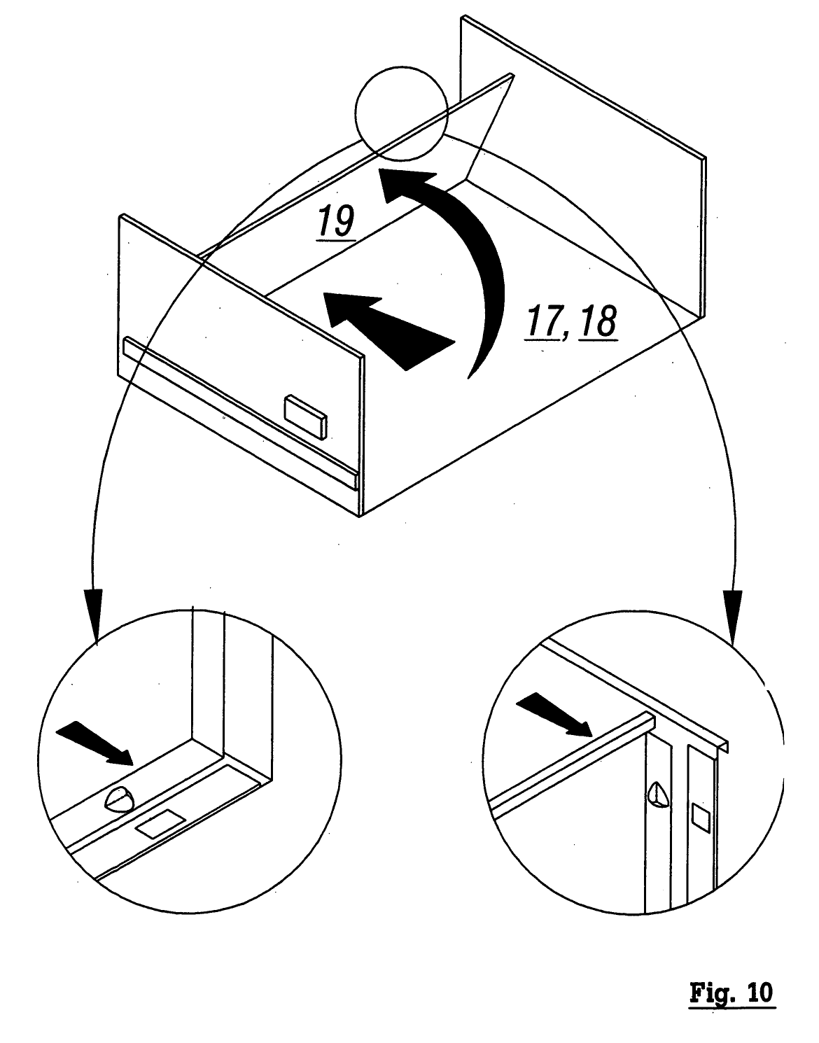

Referring to FIG. 10, attach the back panel 19 to the body that has at its edge a precut rectangular slot to support the button of the drawer back panel 19 to hold it together.

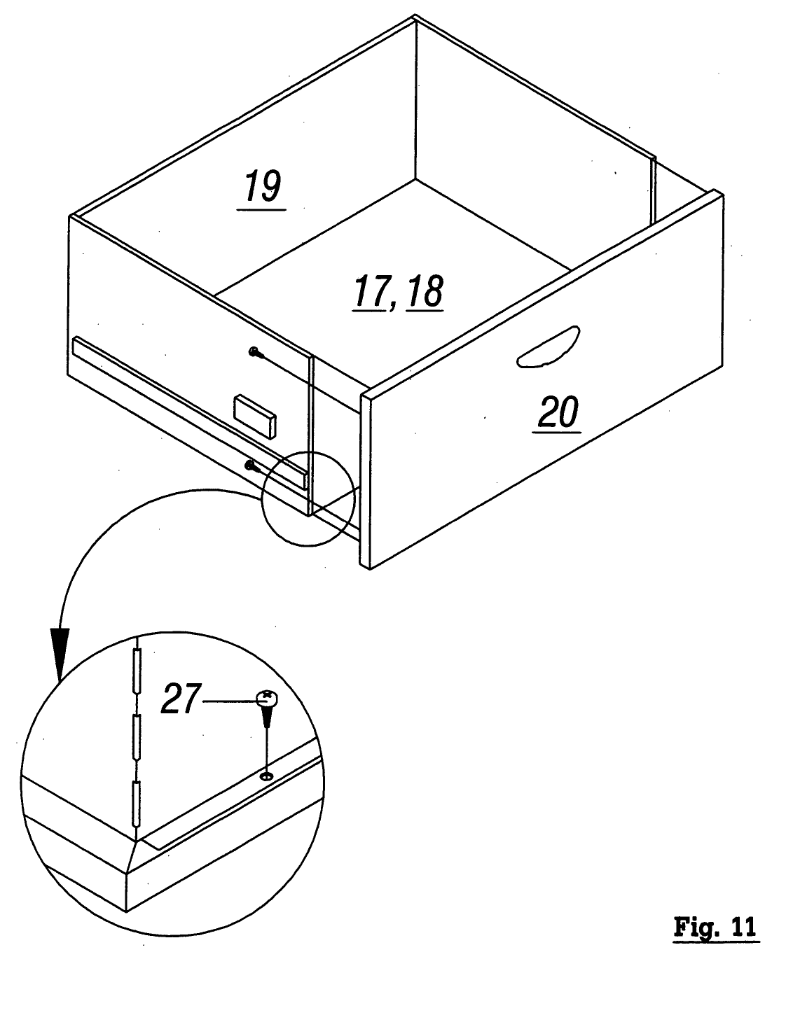

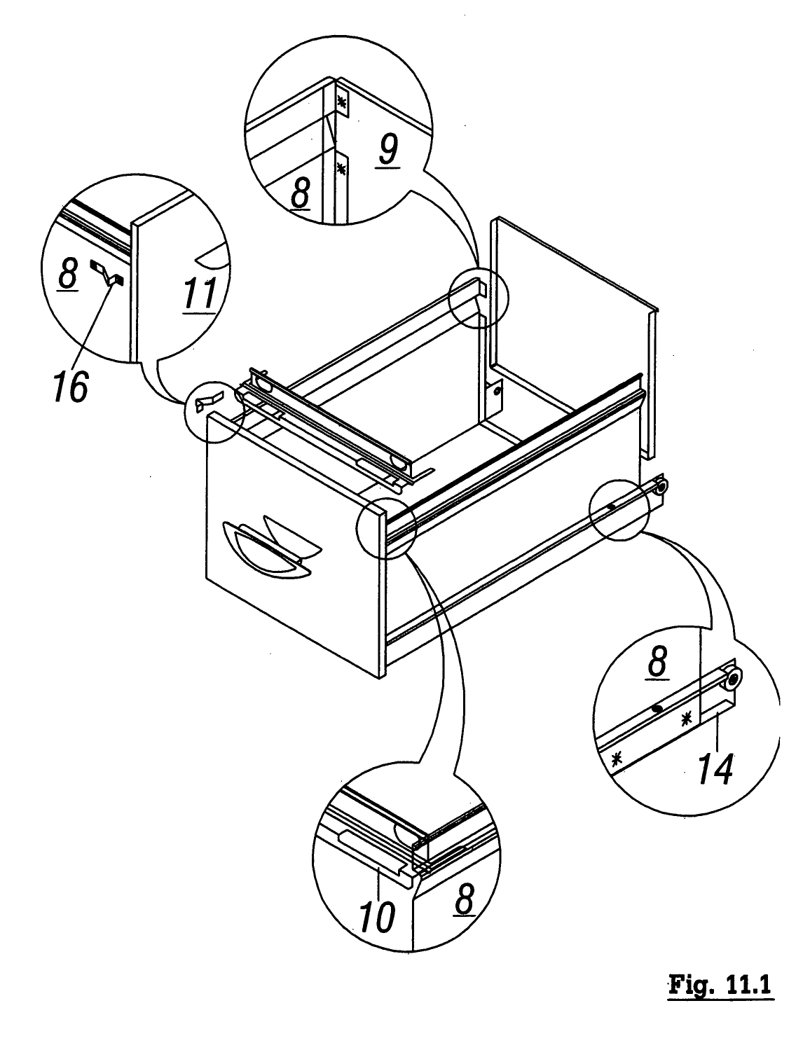

Referring to FIG. 11, attach the front drawer panel to the drawer body with four screws 27.

Referring to FIG. 11.1, spot weld the components where indicated to make the drawer strong, rigid, and stable.

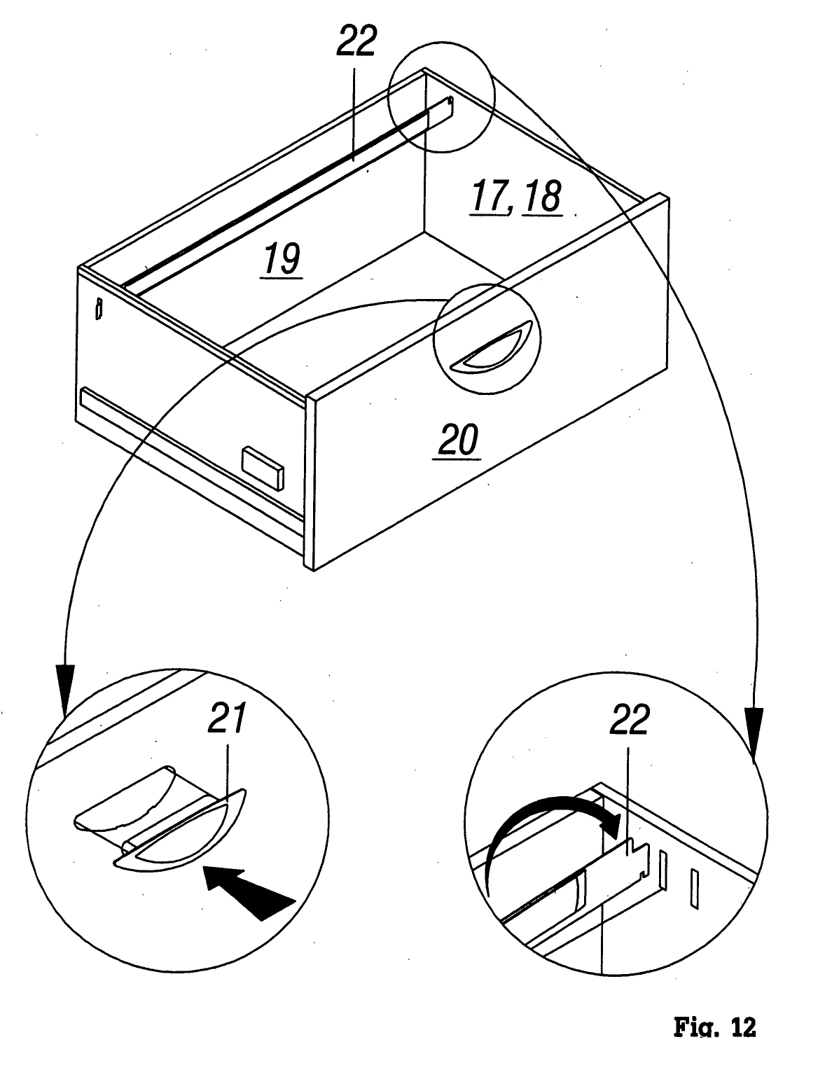

Referring to FIG. 12, snap in the handle 21 to the front drawer. The C-shaped handle is especially designed to suit the cabinet by pressing into the precut slots that will lock properly with the front drawer. Then, install the hanging rail bar 22 at the position indicated. There are two hanging rail bars for each drawer.

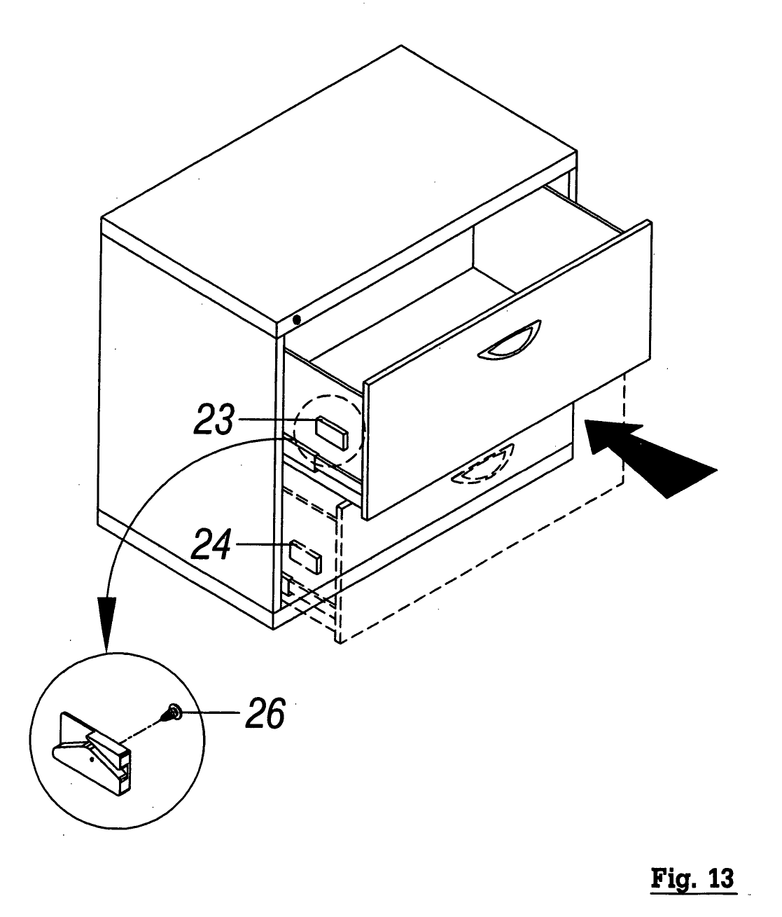

Referring to FIG. 13, attach the plastic ramp 23 to the top drawer and the plastic ramp 24 to the bottom drawer, both with screws 28. After assembly of the drawers is complete, insert the drawers into the cabinet body.

1. Lock System

Composed of Extendible Element Locking System and Interlock System by using common Lock Bar as follow:

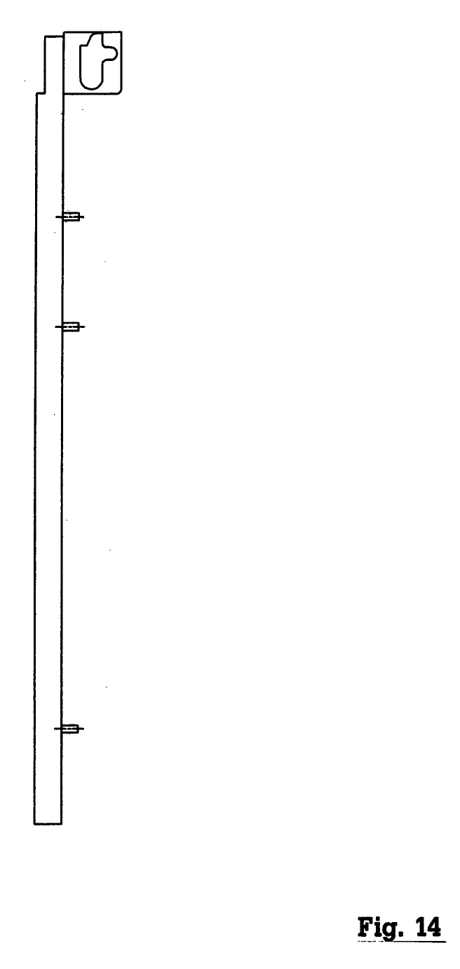

1.1 Lock Bar there are 3 pins (FIG. 14) that will lock the drawer as soon as the key lock and the interlock will work all the time whether the key lock or not. When we open 1 drawer, the other will not be able to open (for the safety to protect the cabinet tipping over) and will protect the drawers to be opened at the same time.

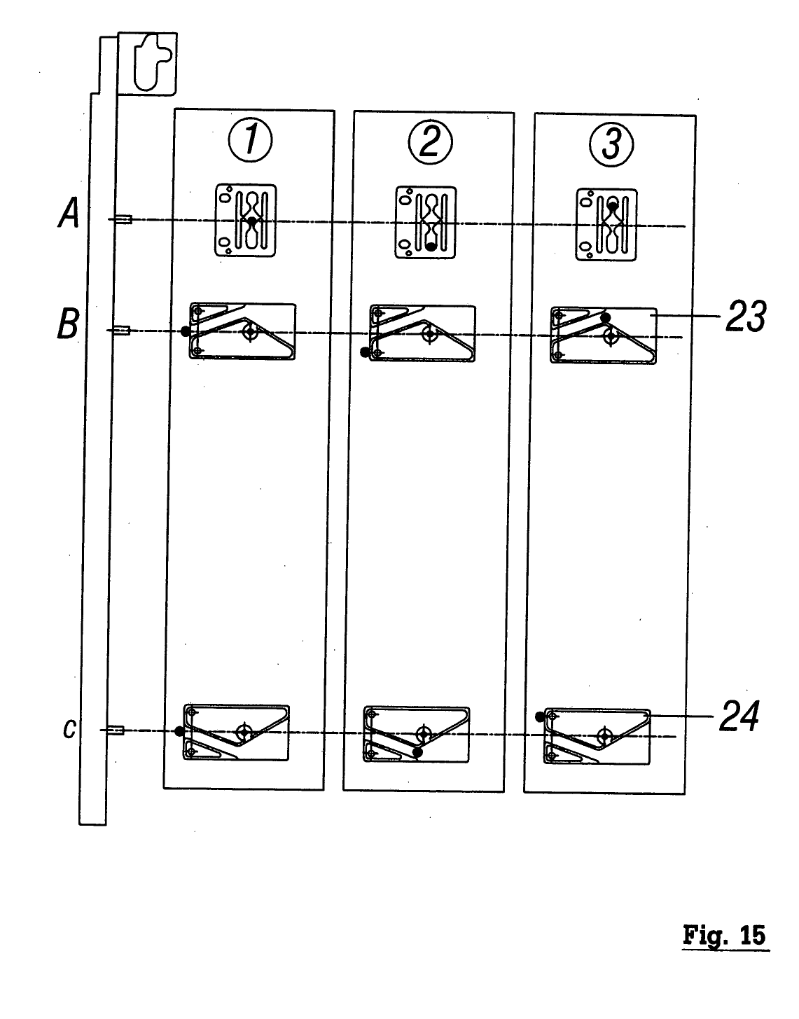

1.2 Extendible Element Locking System and Interlock System will use the common lock bar by locking with the top and bottom plastic ramp (FIG. 15) and interlock plastic as following mechanism: When open the bottom drawer (FIG. 2 of 15) the pin of lock bar A,B,C will move downward then pin B will block the plastic ramp of upper drawer so the upper drawer can not open. In the same way, when open the upper drawer (FIG. 3 of 15) the pin of lock bar will move upward then pin C will block the plastic ramp of bottom drawer so the bottom drawer can not open. For Welded unit use lock system by Lock bar is inside the front edge of left panel. The lock bar have pin to lock each drawer.

2. Mounting of Case Slide System

2.1 Can attach the case rail slide by using the rear end of slide mounted with the bracket that fixed by welding with the back panel (in order to be able to use the 16″ rail instead of 16½″ which is not the standard size) and front end of the rail mounted with side panel with bolts. For welded unit, attach the case rail with the cabinet body by spot welding to make it rigid, strong and can accept more loading of each drawer.

3. Mounting of Case Structure by Cross Beam System

3.1 By using 2 Cross U-Beams Top & Bottom U-Beam will be assembled with top and bottom panel by inserting at the edging of side panel both top and bottom and will fix the beam with bolt. With both beams will increase the stability and rigidity for the cabinet.

4. Hanging Rail ail Type

Case rail is produced by steel pipe going through the process of Cold Forming in order to get the strong hanging rail and not bend when loaded with heavy filing. It is smooth finishing without sharp edge and curve frame that can hang the file properly. For welded unit, in each drawer can hang the file in 2 direction. Both direction make it easier and convenient for using.

Steel Cabinet Drawer File composed of 2 main item is cabinet body and drawer body.

Cabinet Body

For Steel Cabinet with drawers (Knock-Down) composed of Top Panel & Bottom Panel, Left & Right Panel, Back Panel, Top & Bottom U-Beam to hold it together by using Lock taps, screws and C form flange to make the cabinet structure body stability and rigidity. For Steel Cabinet (Welded unit) using spot welding to hold all the parts together in order to make the structure body stability and rigidity.

Drawer Body

Drawer of Knock-Down unit composed of Drawer body assemble with Drawer front by using Screws to hold it together as one unit and using flange to hold Back Drawer with Drawer. For Welded Drawer uses the same system as the welded cabinet structure by using spot welding in order to make it stability and rigidity. After assembled as one unit, it will be strong and look vigorous, beautiful and safety which easier to use.

1. A lock system for a file drawer having an extendable element locking system and interlock system having a common lock bar, comprising:
a lock bar having three pins (FIG. 14) that will lock the drawer whether the key lock is locked, and that will prevent more than one drawer from opening at the same time whether the locking system is locked or unlocked.

2. The lock system recited in claim 1, wherein the common lock bar selectively engages the top and bottom plastic ramp (FIG. 15) and interlock plastic so that when the bottom drawer is opened, a pin of lock bar engages the plastic ramp of the upper drawer so that the upper drawer can not open, and when the upper drawer is open, a pin on the lock bar engages the plastic ramp of the bottom drawer so that the bottom drawer can not open.

3. The lock system recited in claim 2, wherein the lock bar is located inside the front edge of the left panel.

4. The lock system recited in claim 3, wherein the lock bar has a pin to lock each drawer.

5. A case sliding system for a file drawer, comprising a case rail slide having a rear end mounted with a bracket that is fixed by welding to the back panel so that a 16″ rail instead of 16.5″ rail can be used, and the front end of the rail is mounted to the side panel with bolts.

6. The case slide system recited in claim 5, wherein the case rail is welded to the cabinet body to make it rigid, strong and capable of accepting a heavier load in each drawer.

7. A file cabinet having top, bottom, left side, right side, and back panels, comprising a first U-beam connecting the top of the left and right side panels, and a second U-beam connecting the bottom of the left and right side panels, to increase the rigidity of the cabinet.

8. A hanging rail for use in a file drawer comprising a case rail that is produced from steel that has been cold formed in order to improve the strength of the rail.

9. The hanging rail recited in claim 10, wherein the case rail is finished to remove any sharp edges.
